(19) United States
(12) Patent Application Publication
(10) Pub. No.: US 2017/0369069 A1
(43) Pub. Date: Dec. 28, 2017

(54) DRIVING BEHAVIOR ANALYSIS BASED ON VEHICLE BRAKING

(71) Applicant: GM Global Technology Operations LLC, Detroit, MI (US)

(72) Inventors: Chih-hung Yen, Bloomfield Hills, MI (US); Paul E. Krajewski, Troy, MI (US); Taeyoung Han, Bloomfield Hills, MI (US)

(21) Appl. No.: 15/189,563

(22) Filed: Jun. 22, 2016

(51) Int. Cl. B60W 40/09

(52) U.S. Cl. CPC B60W 40/09; B60W 2510/18

(57) ABSTRACT

A system, for use in evaluating operation of a vehicle, includes a hardware-based processing unit, and a non-transitory computer-readable storage component including various functioning modules. The modules in various embodiments include an input module that, when executed by the hardware-based processing unit, receives, from a vehicle-braking sensor, braking data indicting characteristics of a braking event at the vehicle. The system in some implementations includes an input unit receiving the braking data from the sensor and passing it to a braking-monitoring module. The braking-monitoring module, when executed by the hardware-based processing unit, determines, based on the braking data, whether the braking event is within an acceptable pre-established limit. The technology in various embodiments includes processes performed by the system and algorithms used therein.

### TECHNICAL FIELD

The present disclosure relates generally to vehicles and, more particularly, to systems, algorithms, and processes for analyzing driving behavior based on characteristics of vehicle braking episodes.

### BACKGROUND

This section provides background information related to the present disclosure which is not necessarily prior art.

In any transportation system, safe vehicle operation is principle goal. In addition to accident avoidance, and thereby injury avoidance, safer driving is gentler on the vehicle, minimizing wear, prolonging vehicle-part and overall vehicle life, and lowering maintenance costs.

Despite the high importance of safe vehicle operation, though, in most cases, though, vehicle-operation training ends after an initial driving training program.

Some industries, such as the commercial airline and trucking industries, may require periodic testing of operators. The testing does not reveal how the operators are operating their vehicles on a daily basis, though.

Many vehicle operators are motivated to drive safely on a regular basis by financial reasons. By avoiding accidents and traffic tickets, they avoid paying for repairs, other drivers, the government, and more to their insurance company. These incentives are often not enough to discipline people to operate their vehicles safely consistently over time, though, as they seek ways to avoid getting caught (e.g., radar detectors) or drive only well enough to avoid accidents, which is far from optimal operation.

### SUMMARY

In one aspect, the present technology relates to a system, for use in evaluating operation of a vehicle. The system includes a hardware-based processing unit and a non-transitory computer-readable storage component. The system in various implementations includes an input unit, such as, but not limited to a physical input part, a transceiver, or other communications- or data-receiving structure. The storage includes an input module that, when executed by the hardware-based processing unit, receives, from a vehicle-braking sensor, braking data indicting characteristics of a braking event at the vehicle. And the storage includes a braking-monitoring module that, when executed by the hardware-based processing unit, determines, based on the braking data, whether the braking event is within an acceptable pre-established limit.

In some embodiments, the vehicle-braking sensor and/or any other relevant part of the vehicle, such as a vehicle-user interface, are part of the system.

The braking-monitoring module, in determining whether the braking event is within the acceptable pre-established limit, when executed by the hardware-based processing unit, compares the braking data to a pre-established braking threshold.

The braking-monitoring module, when executed by the hardware-based processing unit, in some cases determines, based on the braking data, which category the braking event belongs of: (i) satisfactory braking, or braking within the acceptable pre-established limit, (ii) excessive braking, and (iii) dragging braking.

The braking-monitoring module, when executed by the hardware-based processing unit, may determine, based on the braking data, whether the braking event constitutes an aggressive-braking event.

The braking-monitoring module, when executed by the hardware-based processing unit, can determine, based on the braking data, whether the braking event constitutes a poor-braking-habit event, such as aggressive braking.

The braking-monitoring module, in determining whether the braking event is within the acceptable pre-established limit, when executed by the hardware-based processing unit, in some cases determines whether the braking event is within the acceptable pre-established limit based on the braking data and context data. The braking context data can include any of context data indicating regional braking trends; context data indicating characteristics of historic braking events for an operator of the vehicle initiating the present braking event; context data indicating date of braking event; and context data indicating time of day of braking event, as a few examples.

The non-transitory computer-readable storage component further comprises an operator-reporting module that, when executed by the hardware-based processing unit, may generate or select an operator communication indicating results of determining whether the braking event is within the acceptable pre-established limit, and provides the operator communication via a vehicle output device for receipt by an operator of the vehicle.

The non-transitory computer-readable storage component further comprises a third-party-reporting module that, when executed by the hardware-based processing unit, may generate or select a third-party communication indicating results of determining whether the braking event is within the acceptable pre-established limit, and sends the third-party communication for receipt by a third-party distinct from an operator of the vehicle.

The third-party is an insurance company insuring the vehicle.

In another aspect, the present technology relates to the non-transitory computer-readable storage system described above, for use with a processing unit, in evaluating operation of a vehicle.

In still other aspects, the technology relates to algorithms used in the systems described and processes performed by the system.

Other aspects of the present technology will be in part apparent and in part pointed out hereinafter.

### DESCRIPTION OF THE DRAWINGS

FIG. 1 illustrates schematically an example vehicle of transportation, with local and remote computing devices, according to embodiments of the present technology.

FIG. 2 illustrates schematically more details of the example vehicle computer of FIG. 1 in communication with the local and remote computing devices.

FIG. 3 shows another view of the vehicle, emphasizing example memory components.

FIG. 4 shows interactions between the various components of FIG. 3, including with external systems.

FIG. 5 illustrates an example flow of operations, corresponding to the interactions of FIG. 4, including exemplary inputs and outputs of the process.

FIG. 6 is a chart plotting vehicle brake-line pressures (x-axis) against vehicle deceleration rates (y-axis).

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

I. Technology Introduction

The present disclosure describes, by various embodiments, systems, algorithms, and processes for analyzing driving behavior based on characteristics of vehicle braking episodes.

The technology in some implementations includes performing any of various additional actions, including reporting results of the analysis to a vehicle driver, an owner of the vehicle, such as a fleet operator or employer, to authorities, such as a government traffic agency, or to an interested commercial entity such as an insurance company.

An insurance company may use the information in any of a variety of ways, such as to determine ways to improve customer driving or braking habits, particularly, such as via education or messaging to the operator, similar operators, or all driving customers. The company may also use the information to categorize or re-categorize a driver, and possibly to change a rate or similar.

In some implementations, the system is configured to provide information to third-parties, such as an insurance carrier or cloud system 50 only with operator consent. Consent can be provided in various ways such as by a vehicle HMI, a phone app, phone call, website, the like or other. Requiring opt-in promotes privacy for operators. Third-parties, benefiting from the information, may offer incentives to operators to consent to sharing their driving, or braking, information, such as by an insurance company offering a discount, such as to an insurance premium, in exchange for the operator consenting to the vehicle 10 or system sharing the braking data from the operator's use of the vehicle 10.

Other actions that the technology performs includes, in a contemplated embodiment, adjusting vehicle functions or settings, such as of an automatic-braking system (ABS), vehicle warning or notification systems, the like, or other.

Actions can also include preparing reports based on the analysis and storing the report and/or underlying data for later reporting or use in system operations. The information can be stored locally, at the vehicle or smartphone companion app, for instance, or to a remote computing system, such as a server or other remote computing, or ‘cloud,’ resource.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trolleys, trains, manufacturing equipment (for example, forklift), construction machines, and agricultural machinery, or of warehouse equipment, the like, and other.

While select examples of the present technology describe implementation at vehicles, in communication with local or remote systems performing ancillary or otherwise related functions (e.g., cloud or server functions), in contemplated embodiments the technology is implemented largely at a non-vehicle apparatus, such as by being implemented largely at a cloud or remote computing system or a mobile device programmed with an application customized for the purpose.

And while select examples of the present technology describe a focus on safe or good driving from the perspective of safe braking, the same principles provided can be extended to other driving-quality indicators, such as acceleration (too fast wears on car and increases likelihood of accident or ticket), turning or yaw rates (again, too fast wears on car and increases likelihood of accident or ticket), and following distance—following too closely behind a vehicle in front of a subject vehicle increases likelihood of accident and need for aggressive braking, as just a few examples.

And while select examples of the present technology describe manual-operation vehicles, or vehicle operated manually, by a human driver, the technology is not limited to analysis and responsive activity regarding human driving. The technology can be used to analyze vehicle operation of autonomous-capable driving vehicles being driven autonomously. References herein to characteristics or actions of an operator, for instance, should be considered to disclose analogous implementations regarding an automated operator.

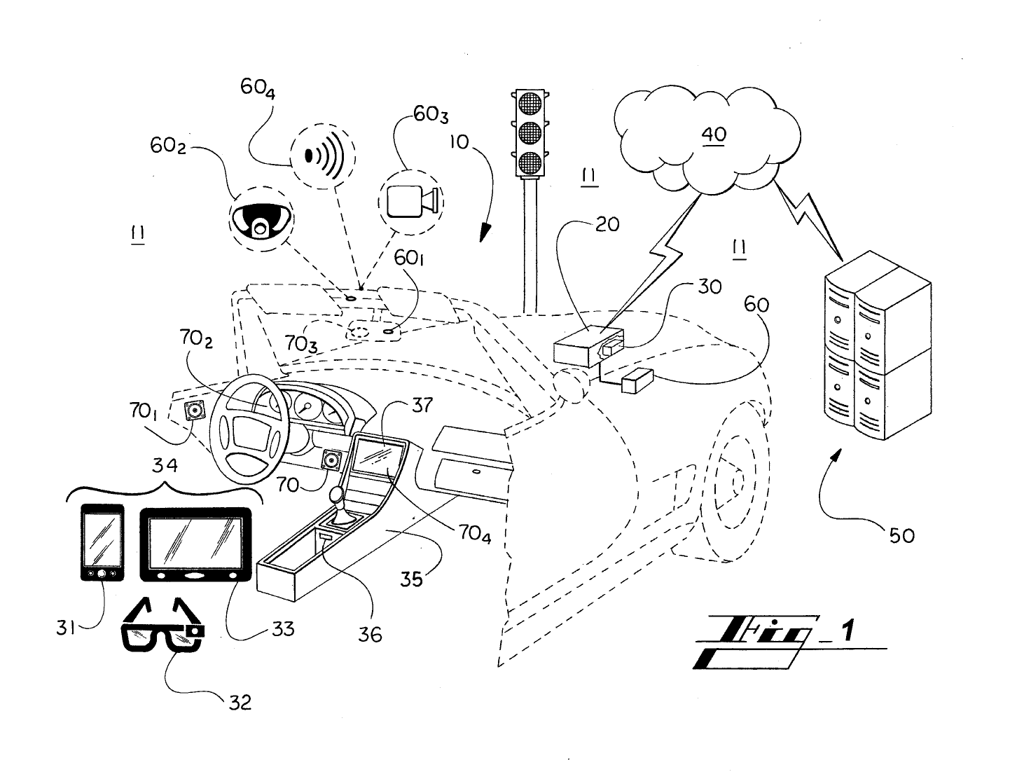

II. Host Vehicle—FIG. 1

Turning now to the figures and more particularly the first figure, FIG. 1 shows an example host structure or apparatus 10 in the form of a vehicle.

The vehicle 10 includes a hardware-based controller or controller system 20. The hardware-based controller system 20 includes a communication sub-system 30 for communicating with mobile or local computing devices 34 and/or external networks 40.

By the external networks 40, such as the Internet, a local-area, cellular, or satellite network, vehicle-to-vehicle, pedestrian-to-vehicle or other infrastructure communications, etc., the vehicle 10 can reach mobile or local systems 34 or remote systems 50, such as remote servers.

Example mobile or local devices 34 include a user smartphone 31, a first example user wearable device 32 in the form of smart eye glasses, and a second example user wearable device 33 in the form of a smart watch, and are not limited to these examples. Other example wearables 32, 33 include smart apparel, such as a shirt or belt, an accessory such as arm strap, or smart jewelry, such as earrings, necklaces, and lanyards.

Another example mobile or local device is a user plug-in device, such as a USB mass storage device, or such a device configured to communicate wirelessly.

Still another example mobile or local device is an on-board device (OBD) (not shown in detail), such as a wheel sensor, a brake sensor, an accelerometer, a rotor-wear sensor, a brake lining wear sensor, a throttle-position sensor, a steering-angle sensor, a revolutions-per-minute (RPM) indicator, brake-torque sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output, human-machine interface (HMI).

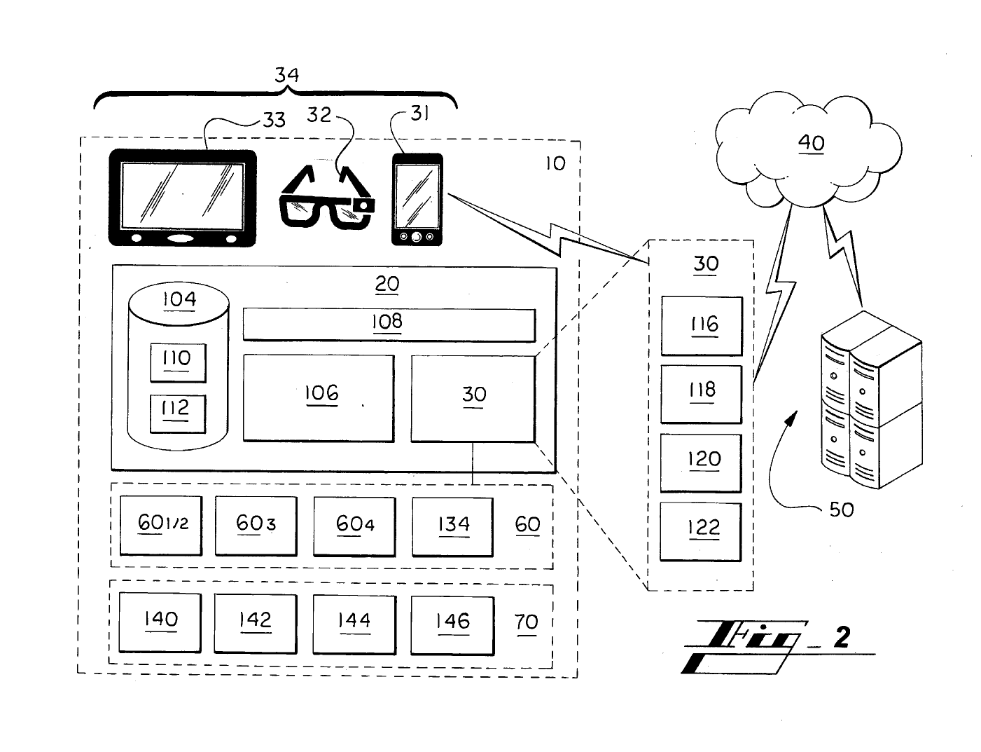

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (601, 602, etc.) are also shown.

Sensor data relates to features such as vehicle operations, vehicle position, and vehicle pose, user characteristics, such as biometrics or physiological measures, and environmental-characteristics pertaining to a vehicle interior or outside of the vehicle 10.

Example sensors include a camera 601 positioned in a rear-view mirror of the vehicle 10, a dome or ceiling camera 602 positioned in a header of the vehicle 10, a world-facing camera 603 (facing away from vehicle 10), and a world-facing range sensor 604. Intra-vehicle-focused sensors 601, 602, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 603, 604 sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Local devices 34 (e.g., user phone, user wearable, or user plug-in device) can be considered as sensors 60 as well, such as in embodiments in which the vehicle 10 uses data provided by the local device based on output of a local-device sensor(s). The vehicle system can use data from a user smartphone, for instance, indicating user-physiological data sensed by a biometric sensor of the phone.

The vehicle 10 also includes cabin output components 70, such as audio speakers 701, and an instruments panel or display 702. The output components may also include dash or center-stack display screen 703, a rear-view-mirror screen 704 (for displaying imaging from a vehicle aft/backup camera), and any vehicle visual display device 37.

III. On-Board Computing Architecture—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

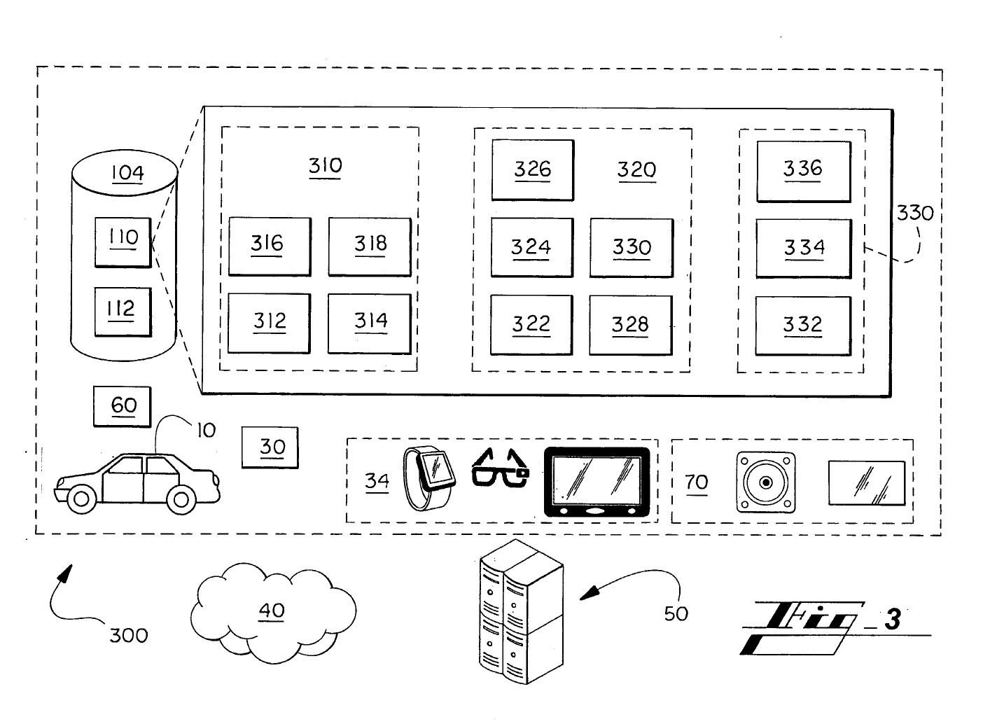

The data storage device 104 includes one or more storage modules 110 storing computer-readable code or instructions executable by the processing unit 106 to perform the functions of the controller system 20 described herein. The modules and functions are described further below in connection with FIGS. 3-5.

The data storage device 104 in some embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controller system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to the vehicle and in communication with the vehicle.

Example remote systems 50 include a remote server (for example, application server), or a remote data, customer-service, and/or control center. A user computing or electronic device 34, such as a smartphone, can also be remote to the vehicle 10, and in communication with the sub-system 30, such as by way of the Internet or other communication network 40.

An example control center is the OnStar® control center, having facilities for interacting with vehicles and users, whether by way of the vehicle or otherwise (for example, mobile phone) by way of long-range communications, such as satellite or cellular communications. OnStar is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 604, such as radar or sonar, directed away from the vehicle, such as for supporting autonomous driving. In some embodiments a camera is used to sense range.

Visual-light cameras 603 directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 603 and the range sensor 604 may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 604 may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (601, 602, etc.) configured and arranged (e.g., positioned and fitted in the vehicle) to sense activity, people, cabin environmental conditions, or other features relating to the interior of the vehicle. Example cabin sensors (601, 602, etc.) include microphones, in-vehicle visual-light cameras, seat-weight sensors, user salinity, retina or other user characteristics, biometrics, or physiological measures, and/or the environment about the vehicle 10.

The cabin sensors (601, 602, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 601, 602, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any known sensor for measuring an environment of the vehicle, including those mentioned above, and others such as a precipitation sensor for detecting whether and how much it is raining or snowing, a temperature sensor, and any other.

Sensors for sensing user characteristics include any biometric or physiological sensor, such as a camera used for retina or other eye-feature recognition, facial recognition, or fingerprint recognition, a thermal sensor, a microphone used for voice or other user recognition, other types of user-identifying camera-based systems, a weight sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to audio speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

IV. Additional Vehicle Components—FIG. 3

FIG. 3 shows an alternative view 300 of the vehicle 10 of FIGS. 1 and 2 emphasizing example memory components, and showing associated devices.

As mentioned, the data storage device 104 includes one or more modules 110 for performing the processes of the present disclosure. And the device 104 may include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Any module disclosed can also be viewed a sub-module, and vice versa. Each of the modules and sub-modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

Example modules 110 and constituent sub-modules include:
Input Module 310
   input-interface sub-module 312;
   braking-input-data sub-module 314;
   context sub-module 316; and
   database sub-module 318.
Activity Module 320
   event-classifier sub-module 322;
   context-data, or data-collection, sub-module 324;
   additional-data-analysis sub-module 326;
   customer-reporting sub-module 328; and
   third-party-reporting sub-module 330.
Output Module 330
   customer-communications sub-module 332;
   third-party-communications sub-module 334; and
   reports-and-database-update sub-module 336.

Other vehicle components shown in FIG. 3 include the vehicle communications sub-system 30 and the vehicle sensor sub-system 60. These sub-systems act at least in part as input sources to the modules 110, and particularly to the input interface module 312.

Example inputs from the communications sub-system 30 include identification signals from mobile devices, which can be used to identify or register a mobile device, and so the corresponding user, to the vehicle 10, or at least preliminarily register the device/user to be followed by a higher-level registration.

The communication sub-system 30 receives and provides to the input module 410 data from any of a wide variety of source, including sources separate from the vehicle 10, such as local devices 34, devices worn by pedestrians, other vehicle systems, local infrastructure (local beacons, cellular towers, etc.), satellite systems, and remote systems 50, providing any of a wide variety of information, such as user-identifying data, user-history data, user selections or user preferences contextual data (weather, road conditions, navigation, etc.), program or system updates—remote systems can include, for instance, applications servers corresponding to application(s) operating at the vehicle 10 and any relevant user devices 34, computers of a user or supervisor (parent, work supervisor), vehicle dealerships (e.g., service department), vehicle-operator servers, customer-control center system, such as systems of the OnStar® control center mentioned, or a vehicle-operator system, such as that of a taxi company operating a fleet of which the vehicle 10 belongs, or of an operator of a ride-sharing service.

Example inputs from the vehicle sensor sub-system 60 include and are not limited to:
vehicle dynamic sensors, such as vehicle speed (e.g., tire-rotation) sensor, vehicle acceleration or other movement, such as an inertial-momentum unit (IMU), having one or more accelerometers, a vehicle pose or other dynamics, such as position, speed, acceleration, or height—e.g., vehicle height sensor, brake sensors, steering angle sensor, any other sensors for providing any vehicle gauge or telematics information;
bio-metric/physiological sensors providing bio-metric data regarding vehicle occupants, such as facial features, voice recognition, heartrate, salinity, skin or body temperature for each occupant, etc.;
vehicle-occupant input devices, such as vehicle human-machine interfaces (HMIs), such as a touch-sensitive screen, buttons, knobs, microphones, and the like;
cabin sensors providing data about characteristics within the vehicle, such as vehicle-interior temperature, in-seat weight sensors, and motion-detection sensors; and
environmental sensors providing data about conditions about a vehicle, such as from external camera, distance sensors (e.g., LiDAR, radar), and temperature sensors, precipitation or moisture sensor, or any sensor for sensing or measuring characteristics of an environment of the vehicle.

The view 300 of FIG. 3 also shows example vehicle outputs 70, and user devices 34 that may be positioned in the vehicle 10. Outputs 70 include and are not limited to:
audio-output component, such as vehicle speakers;
visual-output component, such as vehicle screens;
vehicle-dynamics actuators, such as those affecting autonomous driving (vehicle brake, throttle, steering);
vehicle-climate actuators, such as those controlling HVAC system temperature, humidity, zone outputs, and fan speed(s); and
local devices 34 and remote systems 50, to which the system may provide a wide variety of information, such as user-identifying data, user-biometric data, user-history data, contextual data (weather, road conditions, etc.), instructions or data for use in providing notifications, alerts, or messages to the user or relevant entities such as authorities, first responders, parents, vehicle dealerships (e.g., service department), an operator or owner of a subject vehicle 10, or a customer-service center system, such as of the OnStar® control center.

The modules, sub-modules, and their functions are described more below.

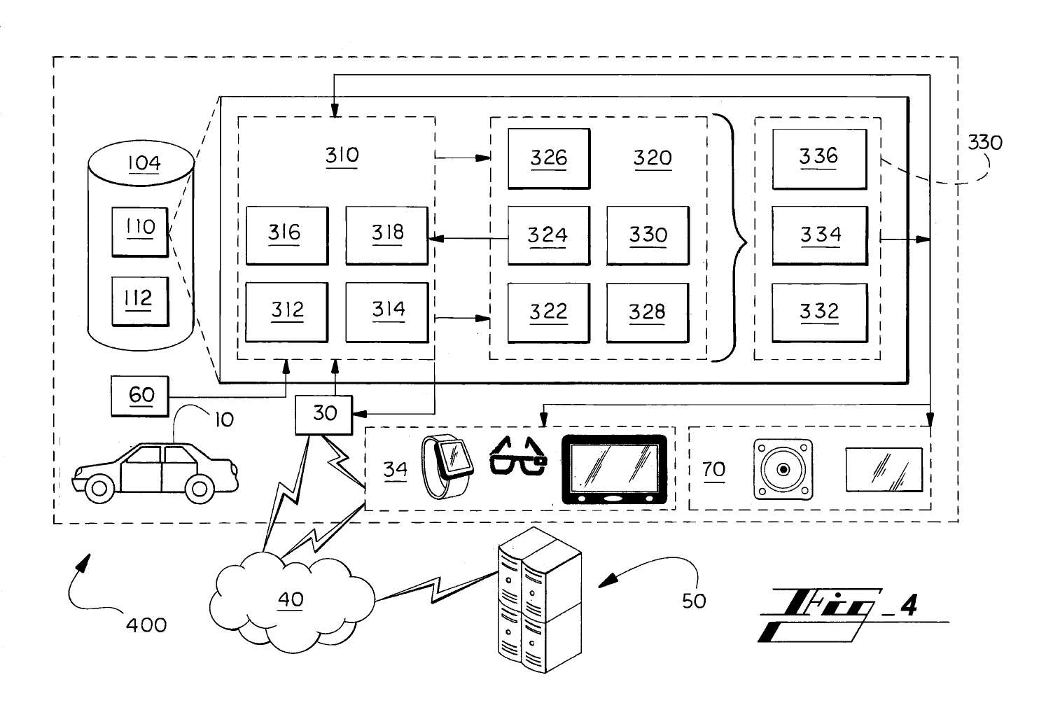

V. Algorithms and Processes—FIGS. 4-6
V.A. Introduction to the Algorithms

FIG. 4 shows an example algorithm, process, or routine represented schematically by a flow 400, according to embodiments of the present technology. The algorithms, processes, and routines are at times herein referred to collectively as processes or methods for simplicity.

Though a single process 400 flow is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 106, a processing unit of an user mobile, and/or the unit of a remote device, executing computer-executable instructions stored on a non-transitory computer-readable storage device of the respective device, such as the data storage device 104 of the vehicle system 20.

The process can end or any one or more operations of the process can be performed again.
V.B. System Components and Functions

FIG. 4 shows the components of FIG. 3 interacting according to various exemplary algorithms and process flows of the present technology.

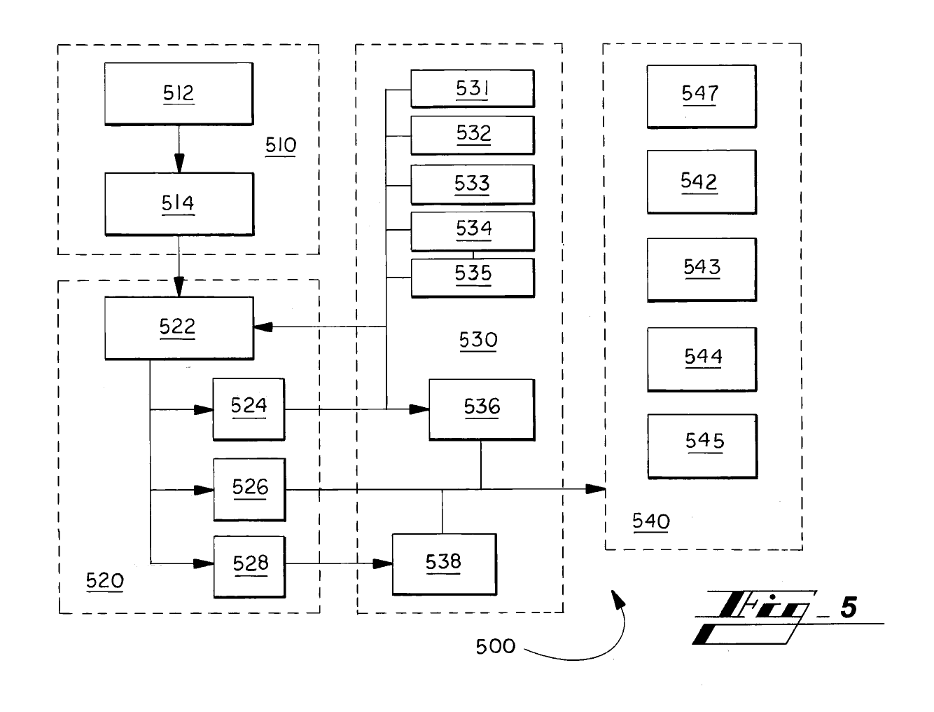

Operations of FIG. 4 are described in part with reference to FIG. 5. FIG.

5 illustrates an example arrangement 500 of operations, inputs, and outputs corresponding to the interactions of FIG. 4, including exemplary inputs and outputs of the process. The

Regarding braking-input data, the arrangement 500 includes four (4) primary groups:
1. A Monitoring group 510;
2. A Classifying group 520;
3. A Data-collecting group 530; and
4. An Analysis-and-Reporting group 540.

Again, the input module 310 includes the input-interface module 312, the braking-input-data module 314, the context module 316, and the database module 318.

Though connections between modules is not shown expressly, sub-modules of the input module interact with each other in various ways to accomplish the functions of the present technology.

The input interface sub-module 312, executed by a processor such as the hardware-based processing unit 106, receives any of a wide variety of input data or signals, including from the sources described herein.

Input sources include vehicle sensors 60 and local or remote devices 34, 50, such as data storage components thereof, via the vehicle communication sub-system 30. Inputs also include a vehicle database, via the database module 304.

The braking-input-data sub-module 314 receives data indicating a manner by which an operator of the vehicle 10 is using a vehicle braking system. In one embodiment, the data indicates at least brake-line pressure, or another indicator of amount of pressure or force applied to the brake system—e.g., brake pedal—by the vehicle operator. The data can also include or be supplemented with data indicating an amount of vehicle deceleration. The brake pressure or force data is correlated with the deceleration data based on time, thus indicating an amount of vehicle decelerations resulting from corresponding applications of the brakes.

Referring briefly to FIG. 5, monitoring of vehicle braking is indicated by block 512, and the braking event, or corresponding braking-data generation or collection is indicated by block 514. Braking events can include a brake pedal being pressed, and can be measured by a pedal-position sensor, and indicated by a brake-light switch.

Returning to the flow 400 of FIG. 4, the context sub-module 316 receives and processes any of a wide variety of inputs relevant to operations of other sub-modules including those of the activity module 320.

Context data can include present, or real-time information, as well as historic information, such as historic traffic data.

Context data can also include information affecting vehicle dynamics, such as road characteristics or conditions, or weather and environmental. Context data can indicate, for instance, road grade, tire-road traction-related information (presence or severity of ice, snow, road slipperiness for any reason), and information indicating wind or other affect vehicle dynamics such as by providing an aerodynamic drag or push on the vehicle 10. Other example datum include relevant vehicle functions, such ABS performance and any powertrain braking affecting the braking event, whether the powertrain braking was implemented on purpose, to slow the vehicle, or was an ancillary affect, such as by normal downshifting.

Example context-data inputs include and are not limited to those shown in the data-collecting group 530 of FIG. 5: regional-braking styles or trends data (531), historic data from a remote source 50 (532), time data (day, date, time, etc.) (533), situational data such as that indicating whether a braking, or braking to an extent made, was necessary (534) (e.g., emergency vehicle starts quickly across street in front of vehicle), and frequency data (535) indicating one or more parameters relating to frequency of braking applications, such as (i) how often the brakes are applied by the user in a time period, (ii) how often the operator applied a threshold amount of pressure to the brakes (e.g., heavy braking) in a time period, or (iii) how often the operator slowed the vehicle by at least a threshold deceleration using the brakes in a time period.

Regarding regional trends, the context data can reflect that drivers in various regions (counties, parts of a country, parts of a state, or city) tend to drive different. While a certain style of braking may be considered harsh in a Western or Southern U.S. state, for instance, the same style may not be outside of a norm for driving in a large Northern city such as Manhattan for instance. Such data can be considered in determining whether a braking event should be categorized as aggressive or harsh driving, or more normal under the circumstances including location.

Along with or instead of location, in a contemplated embodiment, the context data includes time, such as whether the braking event was performed in rush hour after work, or, considering location/region and time, and/or traffic: rush hour in Manhattan, for instance.

For such or other situations, the context data can include data about traffic, weather, road constructions, nearby emergency vehicles, or any situation that may affect operator driving and braking in particular.

Any data used in the system can be stored, at the vehicle and/or elsewhere (e.g., user mobile phone 34 or remote server 50), and the database sub-module 318 is configured to, when executed, facilitate the storing and/or retrieving of the relevant data. Functions of storing and retrieving stored data are referenced above and described further below. For instance, as referenced, output of the input-interface, braking-input, and context sub-modules 312, 314, 316, may be stored via the database sub-module 318, for instance.

Input-module 310 data is passed on, after any formatting, conversion, or other processing, to the activity module 320.

In various embodiments, the activity module 320 includes an event-classifier sub-module 322, or braking-event classifier. The sub-module 322 determines which of multiple categories a braking event falls into, such as normal braking, brake dragging, or hard braking.

In various embodiments, satisfactory braking, or braking within the acceptable pre-established limit, would include any braking that is not seen as problematic, based on system configuration (settings, etc.) such as, but not limited in various embodiments to, excessive braking and dragging braking.

Parameters for qualifying a braking event into such categories—normal braking, brake dragging, or hard braking—are pre-defined by a designer or servicer of the system. Generally, hard braking is braking that is higher than a range of typical braking during safe driving. As described more below, hard braking is not always an indicator of poor, or aggressive, driving. A hard brake may be needed to avoid an unexpected obstacle, for instance.

An example of brake dragging is an operator applying the brake longer than needed, such as by an operator starting to apply the brakes sooner than needed in approaching a stop sign, and so applying the brakes longer than needed in connection with the sign, or such as an operator applying the brakes lightly while in traffic, when the traffic is moving sufficiently for the operator to release the brake. Brake dragging is common in some groups such as some newer and elderly drivers.

With reference to FIG. 5, the classification group 520 includes a classifying function at block 522, and the group 520 includes the following classifications or categories:
524—hard-braking event;
526—normal-braking event; and
528—brake-dragging event.

In various embodiments, determining whether a braking event was normal is viewed as a first-level braking-event classification. Determining which of the three categories above (524, 526, 528) can be viewed as a second-level braking-event classification.

The determination in various embodiments further includes determining a third-level braking classification involving, for hard-braking events (524), determining whether the braking event was aggressive or harsh driving and, for brake-dragging events (528), determining whether the braking event was negative, or over time part of a bad habit.

Regarding aggressive driving, as mentioned, some hard-breaking events are necessary, based on the context, such as an unexpected emergency vehicle or cyclist crossing an intersection, and so should not be considered aggressive braking.

Brake dragging is typically not a driving safety concern. It can have other negative effects, though, such as lowering brake service life.

The system is in some embodiments configured to determine that although the driver braked hard, though not ameliorated or excused by dynamic conditions, such as a person running into the vehicle path, the hard braking will not be considered aggressive, or only an isolated aggressive-braking event, if historic data about the driver's braking indicates that the driver does not regularly, or within threshold frequency, brake hard without justification.

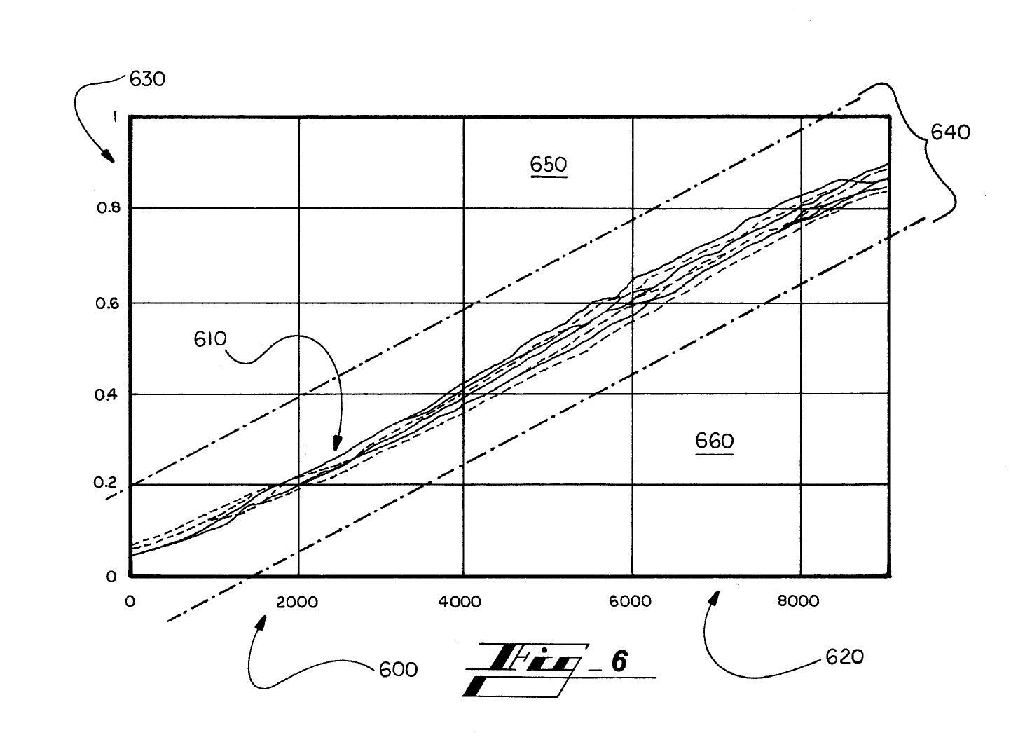

Any of the determinations can process relevant context data, such as, and not limited to, the context data described above regarding the data-collecting group 530. With reference also to the sixth figure, FIG. 6 is a chart 600 plotting brake data 610 indicating vehicle brake-line pressures 620 (x-axis), measured in kPa, and vehicle deceleration rates 630 (y-axis), measured in g. Braking events are considered normal (526) if the brake data 610 falls in a pre-determined range 640).

The range 640 is only an example, such as in size, shape, and location of the range. A braking event indicated by the illustrated pressure/deceleration, brake data 610 is a normal-braking event (526) because is the indicated range 640. Braking data 610 in an upper area 650 of the chart 600 would indicate heavy braking (524), and data 610 in a lower area 660 would indicate a dragging break event (528).

As example parameters, in various embodiments:
Hard breaking can be defined as braking events in which the braking produces a deceleration rate of about 0.4 g or higher, or the brake line pressure exceeds 4000 kPa.
Dragging braking can be defined as braking events in which the brake line pressure is kept at less than about 500 kPa for a period of time great than about 10 seconds.
Normal braking can be defined as having values between hard and dragging braking.

With continued reference to FIG. 4, the context-data, or data-collection, sub-module 324 processes various types of relevant data, generated at the system—e.g., at the braking-event classifying module 322—or received from any of a variety of sources. The function is represented in FIG. 5 at block 541.

Context data can be received to the context-data sub-module 324 via the input-interface sub-module 312 and the communication sub-system 30, for instance.

The context data can be received from a remote or cloud source, such as a remote server or computing system 50. The cloud or remote system 50 can be operated by any interested entity, such as an insurance company or a customer-service company, such as the OnStar® company, as a couple of examples.

The data collected—e.g., generated or received—at the context-data sub-module 324 can be stored at the system, such as at the vehicle storage device 104 via the database sub-module 318, for use in subsequent system operations. The data can be added to context data—reference, e.g., related section 530 of FIG. 5 and FIG. 4 structures and operations such as of the brake-event classifying module 322.

Context data collected can be used, as mentioned, in classifying a braking event. The data can also be used in other functions, such as in generating or selecting messages, reports, or other communications to be communicated to a driver or a third-party, such as an insurance company or a customer-service center such as the OnStar® center.

The system is in various embodiments configured to perform any other useful processing or analysis, of generated or received data, via the additional-data-analysis sub-module 326. The function is represented in FIG. 5 at block 542.

The additional-data-analysis sub-module 326 can identify braking trends of the operator, determine for sharing circumstances in which the driver tends brake hard more, such as before or after work, the like, or other.

The system is in various embodiments configured to determine messages or other communications to provide to the operator and/or third-parties via the customer-reporting and third-party-reporting sub-modules 328, 330. The functions are represented in FIG. 5 at blocks 543, 544, respectively.

Communications to the operator, such as an aggressive-driver warning, can be provided for receipt by the operator via vehicle output devices 70 such as a display screen, light, vehicle haptic system (e.g., seat, steering wheel, brake pedal or foot well vibration), and audio system. Communications can also be provided to the operator via a user device 34, such as one having a companion application related to telematics, or braking, specifically, or an application (e.g., text or SMS message, etc.) facilitating at least communication of messages to the operator. Communications can also be provided to the operator via transmission to an operator address, such as an email or postal address.

The technology is in various embodiments configured to generate or select messages to encourage better or good driving behaviors—e.g., better braking habits. The messages can do so by presenting benefits gained by improved driving, such as fuel saving, vehicle service-life improvement, and less needed maintenance, for instance. Or by negative information, or detriments to continued poor driving or braking, such as increased fuel cost, lower vehicle life, increased maintenance needs, risks or other considerations—e.g., percentages or other statistics—regarding poor driving or braking, such as regarding increased likelihood of accidents, getting a ticket, insurance rates, the like, or other. Support can be provided, such as that hard braking, and to a lesser extent, brake dragging, generates excessive heat, creates high thermal stress, and wears brake pads faster.

Communications can be provided to third-party systems or personnel in similar ways, such as via email, post, or text message.

As mentioned, an insurance company may use the information in any of a variety of ways, such as to determine ways to improve customer driving or braking habits, particularly, such as via education or messaging to the operator, similar operators, or all driving customers. The company may also use the information to categorize or re-categorize a driver, and possibly to change a rate or similar.

And in some implementations, the system is configured to provide information to third-parties, such as an insurance carrier or cloud system 50 only with operator consent. Consent can be provided in various ways such as by a vehicle HMI, a phone app, phone call, website, the like or other. Requiring opt-in promotes privacy for operators. Third-parties, benefiting from the information, may offer incentives to operators to consent to sharing their driving, or braking, information, such as by an insurance company offering a discount in exchange for the operator consenting to the vehicle 10 or system sharing the braking data from the operator's use of the vehicle 10.

While select examples of the present technology describe output in the form of generating reports, messages, warnings, for provision to an operator in real-time, to improve present driving, or to a third-party, in contemplated embodiments, the system is configured to adjust vehicle function otherwise. The functions are represented in FIG. 5 at block 545, and can be implemented via a sub-module of the activity module 320 of FIG. 3, such as a vehicle-control or settings sub-module (not illustrated). Real-time data can be especially helpful for drivers learning or having lowered senses, such as new drivers or elderly.

Example vehicle actions include, and are not limited to, adjusting vehicle functions or settings, such as of an automatic-braking system (ABS), such as a manner by which the ABS intervenes in braking situations, or of a vehicle warning or notification system, such as a timing or manner by which notifications are provided, the like, or other.

Output of the activity module 320 is in various embodiments provided to any of the database sub-module 304, the output module 330, and the vehicle communication sub-system 30 for reaching non-vehicle devices.

The output module 330 includes the customer-communications sub-module 332, the third-party-communications sub-module 334, and the reports-and-database-update sub-module 336. The module 330 can also include a vehicle-control-setting sub-module (not illustrated) corresponding to the contemplated vehicle control embodiments mentioned above.

In various embodiments the output sub-modules 332, 334, 336 format, convert, or otherwise process output of the activity module 320 prior to delivering same to the output components or otherwise implementing system results.

As shown, example system output components include vehicle speakers, screens, or other vehicle outputs 70. Example system output components can also include user devices 34, such as smartphones, wearables, and headphones.

Example system output components can also include remote systems 50 such as remote servers and user computer systems (e.g., home computer). The output can be received and processed at these systems, such as to update a user profile with a determined preference, activity taken regarding the user, the like, or other.

Example system output components can also include a vehicle database. Output data can be provided to the database sub-module 314, for instance, which can store such updates to an appropriate user account of the ancillary data 112.

VI. Additional Structure, Algorithm Features, and Operations

In combination with any of the other embodiments described herein, or instead of any embodiments, the present technology can include any structure or perform any functions as follows:
i. The technology in various embodiments includes system which (1) identifies unsafe driving styles and undesirable driving habits by analyzing vehicle-operators' real-time and logged data, and (2) promotes driving safety and helps to build good driving habits by providing personalized and relevant suggestions or other information (e.g., statistics) to the drivers. Suggestions can be generated based on a wide variety of information, such as information indicating personal driving patterns, operator braking-event history, and regional braking trends.
ii. The technology in various embodiments includes promotes safer driving styles and good driving habits by providing personalized and relevant suggestions, for instance.
iii. The technology in various embodiments includes a process which monitors vehicle, identifies driving styles based on real-time or logged data, reports personal and regional driving patterns, helps inexperienced drivers building good driving habits, and provides driving suggestions for safety, better fuel economy, and longer service lives of components, for instance.
iv. The technology in various embodiments includes a method which isolates the aggressive and unsafe driving profiles form the database.
v. The technology in various embodiments includes a method which detects the driving habits that have adverse effects on the vehicles.
vi. The technology in various embodiments includes actively promoting safe driving by delivering personalized and relevant suggestions.
vii. The technology is in various embodiments configured to identify the frequency and severity of unnecessary hard braking, as they are the key predictive parameter of traffic accidents.
viii. The technology is in various embodiments configured to encourage good driving behaviors by presenting personalized and relevant suggestions or other information, such as benefits gained, such as fuel saving and service life improvement. The driving suggestions are in various embodiments based on the data analytics of the driving data, traffic conditions, and regional patterns. Suggestions or statistics for an operator, which can include data specific to them and some generic to others, can be provided as part of a regular report to the operator, such as a periodic or intermittent reports to the operator. The reports can be sent by a customer-service operation, such as the OnStar® system, electronically (e.g., email) or by post, for instance.
ix. The technology is in various embodiments configured to use remote or cloud resources, such as systems and data of the OnStar® customer-service center, or other telematics tools, such as by sending generated data, from the vehicle 10, for instance, to the resource.
x. The technology is in various embodiments configured to provide data as part of a driving training or certification program. The technology can be implemented on-road for this purpose, in a driving simulator, alone, or a combination. For instance, on-road driving data can be used, in addition to simulated driving data, to analyze operator driving performance and classify their driving behavior, accordingly—e.g., braking style (aggressive, normal, dragging).

VII. Select Advantages

Many of the benefits and advantages of the present technology are described above. The present section restates some of those and references some others. The benefits described are not exhaustive of the benefits of the present technology.

The technology in various embodiments includes actively promoting safe driving by delivering personalized and relevant suggestions.

The technology is in various embodiments configured to assist vehicle owners or users to maintain a healthy vehicle.

The technology is in various embodiments configured to help vehicle operators lower their insurance costs.

The technology is in various embodiments configured to help inexperienced drivers to build better and good driving habits.

VIII. Conclusion

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for use in evaluating operation of a vehicle, comprising:
a hardware-based processing unit;
an input unit; and
a non-transitory computer-readable storage component comprising a braking-monitoring module that, when executed by the hardware-based processing unit, receives, from a vehicle-braking sensor, via the input unit, braking data indicting characteristics of a braking event at the vehicle, and determines, based on the braking data, whether the braking event is within the acceptable pre-established limit.

2. The system of claim 1 further comprising the vehicle-braking sensor.

3. The system of claim 1 wherein the braking-monitoring module, in determining whether the braking event is within the acceptable pre-established limit, when executed by the hardware-based processing unit, compares the braking data to a pre-established braking threshold.

4. The system of claim 1 wherein the braking-monitoring module, when executed by the hardware-based processing unit, determines, based on the braking data, which category the braking event belongs of: braking within the acceptable pre-established limit, excessive braking, and dragging braking.

5. The system of claim 1 wherein the braking-monitoring module, when executed by the hardware-based processing unit, determines, based on the braking data, whether the braking event constitutes an aggressive-braking event.

6. The system of claim 1 wherein the braking-monitoring module, when executed by the hardware-based processing unit, determines, based on the braking data, whether the braking event constitutes a poor-braking-habit event.

7. The system of claim 1 wherein the braking-monitoring module, in determining whether the braking event is within the acceptable pre-established limit, when executed by the hardware-based processing unit, determines whether the braking event is within the acceptable pre-established limit based on the braking data and context data.

8. The system of claim 7 wherein:
the braking event is a present braking event; and
the context data is selected from a group consisting of:
context data indicating regional braking trends;
context data indicating characteristics of historic braking events for an operator of the vehicle initiating the present braking event;
context data indicating date of braking event; and
context data indicating time of day of braking event.

9. The system of claim 1 wherein the non-transitory computer-readable storage component further comprises an operator-reporting module that, when executed by the hardware-based processing unit, generates or selects an operator communication indicating results of the determining, and provides the operator communication via a vehicle output device for receipt by an operator of the vehicle.

10. The system of claim 1 wherein the non-transitory computer-readable storage component further comprises a third-party-reporting module that, when executed by the hardware-based processing unit, generates or selects a third-party communication indicating results of the determining, and sends the third-party communication for receipt by a third-party distinct from an operator of the vehicle.

11. The system of claim 10 wherein the third-party is an insurance company insuring the vehicle.

12. A non-transitory computer-readable storage system, for use in evaluating operation of a vehicle, comprising:
an input module that, when executed by a hardware-based processing unit, receives, from a vehicle-braking sensor, braking data indicting characteristics of a braking event at the vehicle; and
a braking-monitoring module that, when executed by the hardware-based processing unit, determines, based on the braking data, whether the braking event is within an acceptable pre-established limit.

13. The non-transitory computer-readable storage system of claim 12 wherein the braking-monitoring module, in determining whether the braking event is within the acceptable pre-established limit, when executed by the hardware-based processing unit, compares the braking data to a pre-established braking threshold.

14. The non-transitory computer-readable storage system of claim 12 wherein the braking-monitoring module, when executed by the hardware-based processing unit, determines, based on the braking data, which category the braking event belongs of: braking within the acceptable pre-established limit, excessive braking, and dragging braking.

15. The non-transitory computer-readable storage system of claim 12 wherein the braking-monitoring module, when executed by the hardware-based processing unit, determines, based on the braking data, whether the braking event constitutes an aggressive-braking event.

16. The non-transitory computer-readable storage system of claim 12 wherein the braking-monitoring module, in determining whether the braking event is within the acceptable pre-established limit, when executed by the hardware-based processing unit, determines whether the braking event is within the acceptable pre-established limit based on the braking data and context data.

17. The non-transitory computer-readable storage system of claim 12 wherein the non-transitory computer-readable storage component further comprises an operator-reporting module that, when executed by the hardware-based processing unit, generates or selects an operator communication indicating results of the determining, and provides the operator communication via a vehicle output device for receipt by an operator of the vehicle.

18. The non-transitory computer-readable storage system of claim 12 wherein the non-transitory computer-readable storage component further comprises a third-party-reporting module that, when executed by the hardware-based processing unit, generates or selects a third-party communication indicating results of the determining, and sends the third-party communication for receipt by a third-party distinct from an operator of the vehicle.

19. A process, for use in evaluating operation of a vehicle, comprising:
receiving, by an input module of a hardware-based system being executed by a hardware-based processing unit of the system, from a vehicle-braking sensor, braking data indicting characteristics of a braking event at the vehicle; and
determining, by a braking-monitoring module being executed by the hardware-based processing unit, based on the braking data, whether the braking event is within an acceptable pre-established limit.

20. The process of claim 19 wherein the braking-monitoring module, in determining whether the braking event is within the acceptable pre-established limit, when executed by the hardware-based processing unit, compares the braking data to a pre-established braking threshold.
